(19) United States
(12) Patent Application Publication
(10) Pub. No.: US 2026/0176498 A1
(43) Pub. Date: Jun. 25, 2026

(54) Food-safe adhesive strip and method of using a food safe adhesive strip to remove debris from an animal carcass

(71) Applicant: WildTech Inc., Baker City, OR (US)

(72) Inventors: Douglas Schwin, Baker City, OR (US); Bradley Schwin, Baker City, OR (US)

(21) Appl. No.: 18/662,856

(22) Filed: May 13, 2024

Related U.S. Application Data
(60) Provisional application No. 63/502,010, filed on May 12, 2023.

(51) Int. Cl. C09J 7/21; C09J 7/20; C09J 7/22; C09J 7/38

(52) U.S. Cl. CPC C09J 7/21; C09J 7/20; C09J 7/22; C09J 7/38

(57) ABSTRACT

A food-safe adhesive strip that is used to remove hair, dirt, and debris from an animal carcass. The adhesive strip has a food-safe adhesive applied to a paper backing material. The adhesive strips typically are provided in a stack or roll of adhesive strips including a protective material, such as a thin plastic, applied over the adhesive to prevent adjacent strips from sticking together. The adhesive side of the strip is positioned against a portion of the animal carcass, and dirt, hair, and/or debris on the carcass sticks to the adhesive. The adhesive strip is then pulled away from the carcass, removing the dirt, hair, and/or debris. This helps the user obtain a cleaner carcass, which is beneficial in preventing meat spoiling and avoiding contaminating flavors in the meat.

### CROSS-REFERENCE TO RELATED APPLICATIONS

This application claims the benefit of U.S. Provisional Application No. 63/502,010, filed May 11, 2023 the disclosure of which is incorporated by reference.

### FIELD OF THE INVENTION

The presently disclosed technology generally relates to the field of hunting, in particular to processing of game following a harvest. Particular embodiments relate to a novel food-safe adhesive strip and novel method of using a food-safe adhesive strip for removing debris from an animal carcass.

### BACKGROUND OF THE INVENTION

In hunting, a hunter commonly shoots an animal with a firearm or bow. In small-game hunting, such as squirrel or rabbit hunting and big game hunting, such as deer, elk, moose, or other large game animals, the hunter will often remove the skin and fur/hair (referred to collectively herein as “hair”) from the animal carcass while in the field. After removing the skin the remaining carcass includes muscle, bone, connective tissue, and fat. The muscle is the meat that is removed for consumption. This muscle is typically coated by an outer membrane on the muscle that adheres the skin to the carcass, as well as interconnects the various bones and muscle groups. The outer membrane and individual carcass components are typically sticky, and any hair, dirt, and/or plant matter (collectively called “debris”) will stick to the carcass.

The carcass, or its individual components such as leg quarters, are often aged before processing the carcass into useable portions. The meat from the carcass is then typically butchered from the carcass into individual muscle components, cut into portions, such as steaks, or grouped into similar components such as stew meat or meat for grinding. Often the meat is packaged and frozen to preserve the meat for future use. However, the debris must be removed before the meat is aged or butchered, as the debris can impart off flavors and/or textures during the storage, processing, or cooking process. Thus the debris is preferably removed before aging or processing, preferably promptly after skinning of the carcass. Removal of this debris can be difficult and time consuming if significant amount of debris are stuck to the carcass. Some portions of the carcass are particularly sticky, in particular those with large amounts of thin connective tissue, silver skin, or fatty deposits. This often requires a processor to cut the material out, or to individually pluck the debris from the carcass.

However, there is not currently a good product or method to efficiently remove debris from the meat. To properly care for the meat, it is preferable for the hunter to remove this material from the carcass prior to transfer and/or storage of the meat. Keeping the meat debris-free during transport and storage is important for sanitary purposes as well as to avoid tainting the flavor of the meat. What is needed is a convenient and packable device, method for removing debris from a carcass, and kit for removing debris from the carcass.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

What is disclosed is an adhesive strip for use in removal of debris from an animal carcass. The term animal carcass is used to denote the entire carcass, portions of the carcass, or individual muscle or cuts of muscle. The adhesive strip has a carrier sheet, a food-safe adhesive adhered to one side of the strip, and a protective layer, such as a sheet of material preventing contact with the adhesive until the protective sheet is removed. The term food-safe means an adhesive that is approved by the United States Food and Drug Administration for direct food contact. The carrier sheet is preferably a polyethylene terephthalate (PET) plastic, while the protective sheet is a silicone coated kraft paper, although alternate materials can be used without deviating from the spirit of the invention.

The adhesive is approved for direct food contact, and complies with current Food and Drug Administrative rule 175.125. A preferred embodiment of the adhesive has a wide temperature use range for being able to use on meat either in the field, at home, or in a meat processing facility, in both warm weather and sub-freezing temperatures. A preferred embodiment of the food-safe adhesive has an effective temperature range of −65 F to 150 F. The food-grade adhesive preferably an all-weather adhesive that has high tack qualities in cold, wet conditions as well as general purpose bonding applications. Preferably the adhesive is a pressure sensitive adhesive. The carrier strip in a preferred embodiment is 8.5 inches by 4 inches, with the adhesive area being 7.5 inches by 4″, which provides a ½″ edge of a dry, adhesive free border to facilitate handling of the adhesive strips.

The adhesive strips can be provided as a roll of strips to be cut by a hunter in the field. Alternatively, the strips can be provided as pre-cut or pre-sectioned strips. These strips can include perforations for easily dividing strips in the field without the use of a cutting tool such as scissors. Alternatively the carrier sheet can be configured such that the adhesive side of the carrier strip carries the food-safe adhesive, while the back face of the carrier sheet is configured to not adhere to the adhesive. In this embodiment the adhesive strip can be rolled on itself, with the back face of the adhesive strip protecting the food-safe adhesive.

The pre-cut adhesive strips are preferably provided to the user in a kit of adhesive strips. The kit utilizes a sealed pouch having a plurality of adhesive strips within the bag. The pouch is sealed to preserve the integrity of the strips, and to prevent contamination on the strips. Preferably the pouch is resealable, such as by press-seal or zipper seal. The chamber of the pouch is sized to house a plurality of strips. In a preferred embodiment ten strips is provided in each pouch. The strips can be of uniform dimension, or a series of differing sizes. In a preferred embodiment each strip is four inches by eight inches, with the opposing narrow ends of each strip having a ½ inch dry edge that is free of adhesive to facilitate handling of the strip.

In use a hunter removes the protective sheet or layer from the adhesive, exposing the food-safe adhesive. The hunter applies the adhesive side of the carrier material to the carcass or meat being cleaned, causing the adhesive to be pressed against the carcass or meat. The tackiness of the adhesive causes the debris to adhere to the adhesive. The hunter then removes the strip by pulling the strip off the carcass, causing the debris to be pulled off of the carcass.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature

### BRIEF DESCRIPTION OF DRAWINGS

FIG. 1 illustrates an adhesive strip according to the preferred embodiment of the invention.

FIG. 2 illustrates the adhesive strip of FIG. 1

FIG. 3 illustrates a portion of a carcass having debris sticking to the carcass.

FIG. 4 illustrates an adhesive strip according to the embodiment of FIG. 1 being pressed against the portion of a carcass of FIG. 3.

FIG. 5 illustrates the adhesive strip and carcass of FIG. 4 with the adhesive strip being removed from the carcass.

FIG. 6 illustrates the adhesive strip of FIGS. 4 and 5 with debris from the carcass of FIGS. 4 and 5 adhered to the adhesive of the carcass.

FIG. 7 illustrates a portion of a carcass having debris sticking to the carcass.

FIG. 8 illustrates an adhesive strip having debris of FIG. 7 adhered to the food-safe adhesive of the adhesive strip.

FIG. 9 illustrates a preferred embodiment of a kit having a plurality of adhesive strips in a resealable pouch.

### DETAILED DESCRIPTION OF THE INVENTION

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

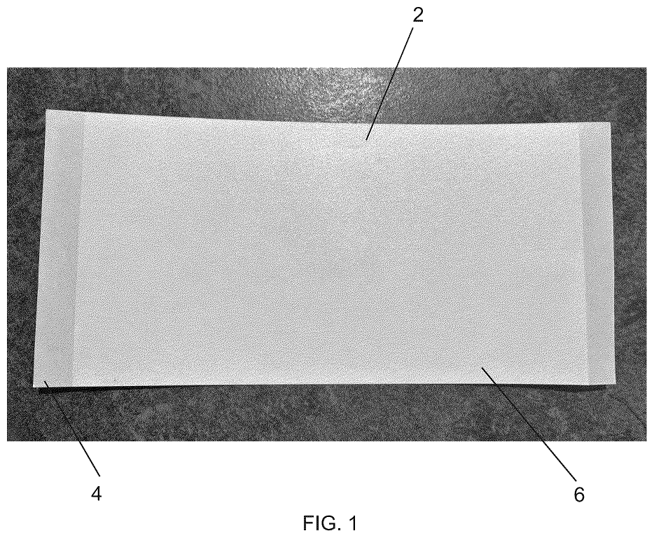

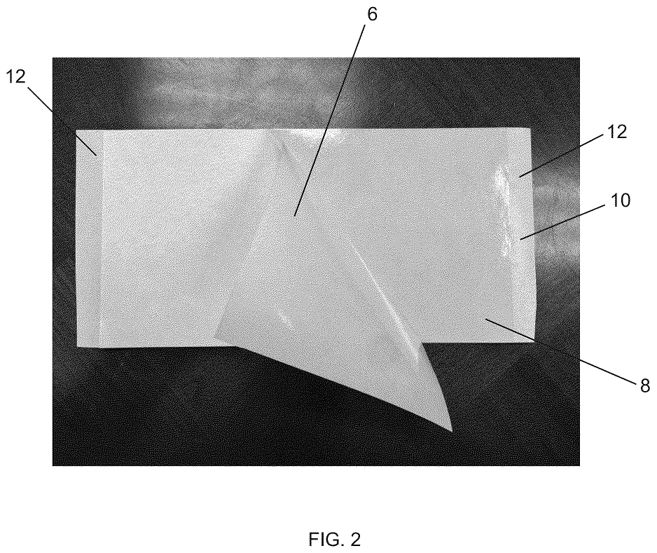

FIG. 1 depicts a preferred embodiment of an adhesive strip. The adhesive strip 2 has a paper backing material 4 and a protective layer 6 that is applied over the adhesive on the paper backing material. The protective material is peeled away from the adhesive as illustrated in FIG. 2. In FIG. 2, the protective material 6 is being peeled away from the adhesive 8 that is placed on the backing paper 10 and note the term paper can be a literal paper or alternative materials such as a plastic backing or other suitable material may be used. The protective layer is constructed of a temporary binding material that is easily peeled from the adhesive layer while leaving the adhesive in place. Preferably each strip has a paper dry edge 12 on either side of the strip to allow for the user to grasp the edge of the paper without having the adhesive material stick to the user.

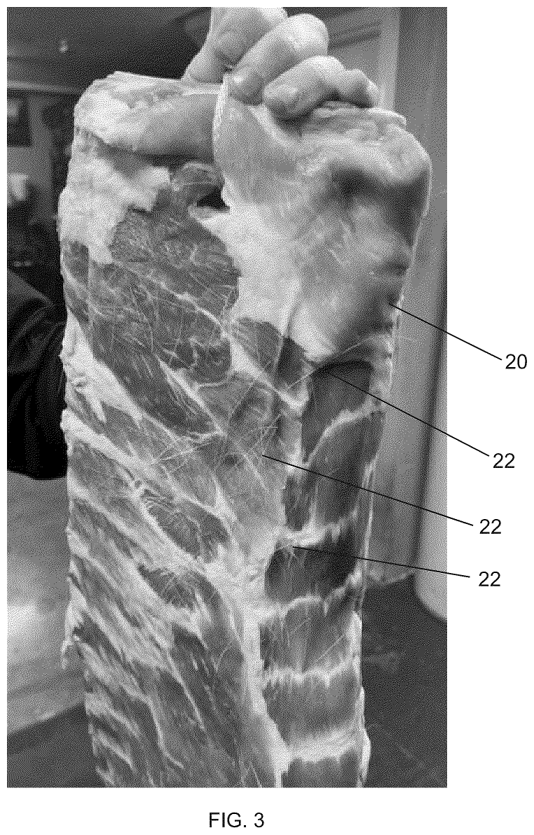

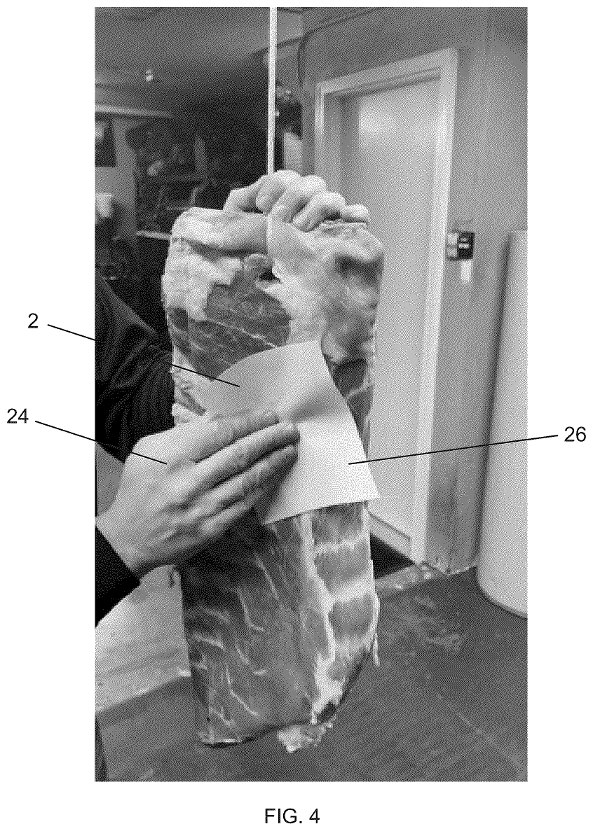

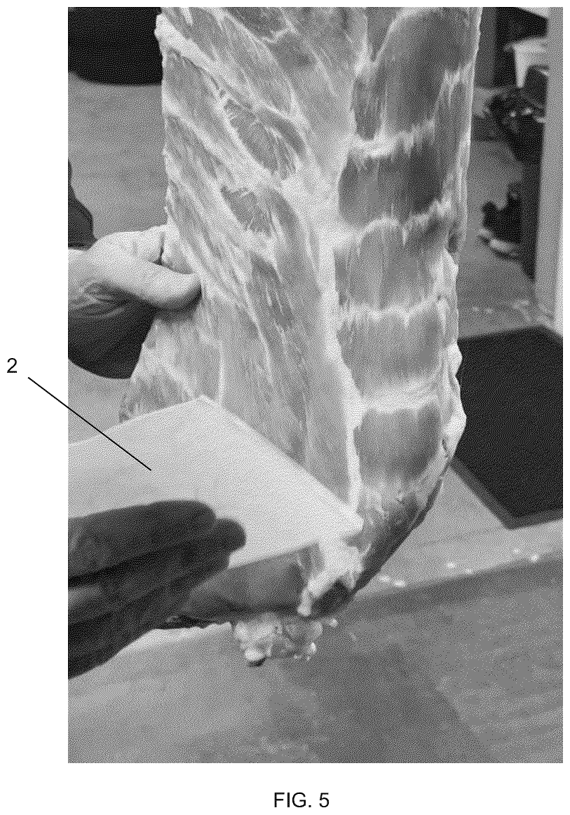

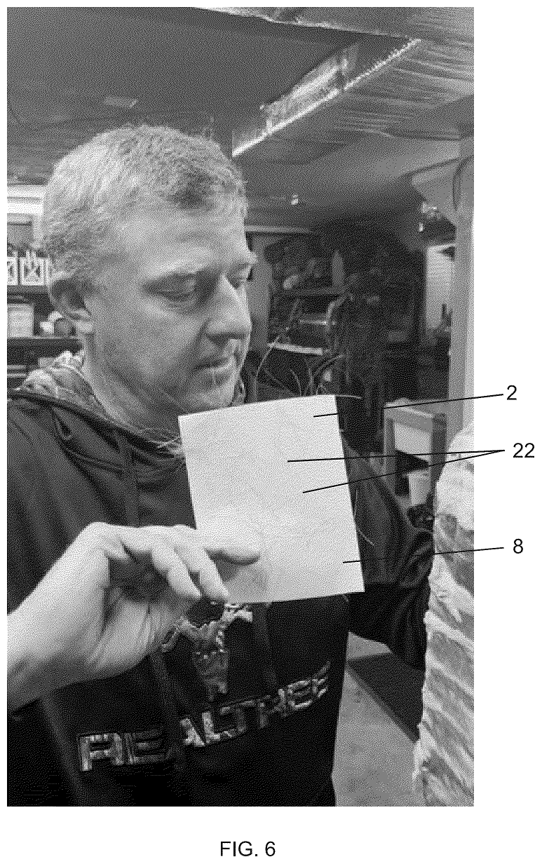

FIGS. 3-6 illustrate the process of removing debris, namely hair, from a section of a carcass. FIG. 3 illustrates a section of a carcass 20 having an amount of hair 22 stuck to the carcass. FIG. 4 illustrates an adhesive strip having the protective layer removed with the user's hand 24 position on the back side 26 of the adhesive strip. The adhesive on the adhesive side of the adhesive strip is pressed or positioned against the surface of the carcass with sufficient pressure and force to adhere the hair of the carcass to the adhesive. FIG. 5 illustrates the adhesive strip 2 being removed from the carcass. The hair has adhered to the adhesive, causing the hair to be pulled off of the carcass as the adhesive strip is removed. FIG. 6 illustrates the adhesive side of the adhesive strip having the hair stuck to the adhesive.

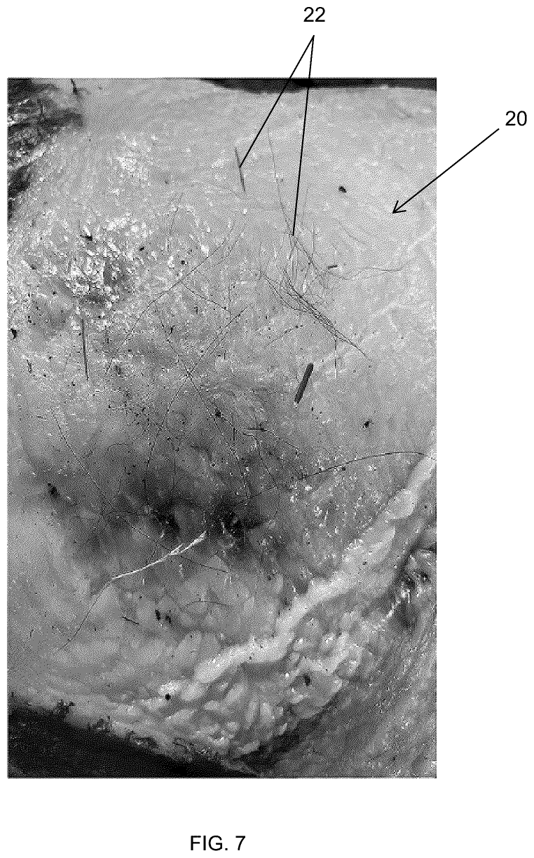

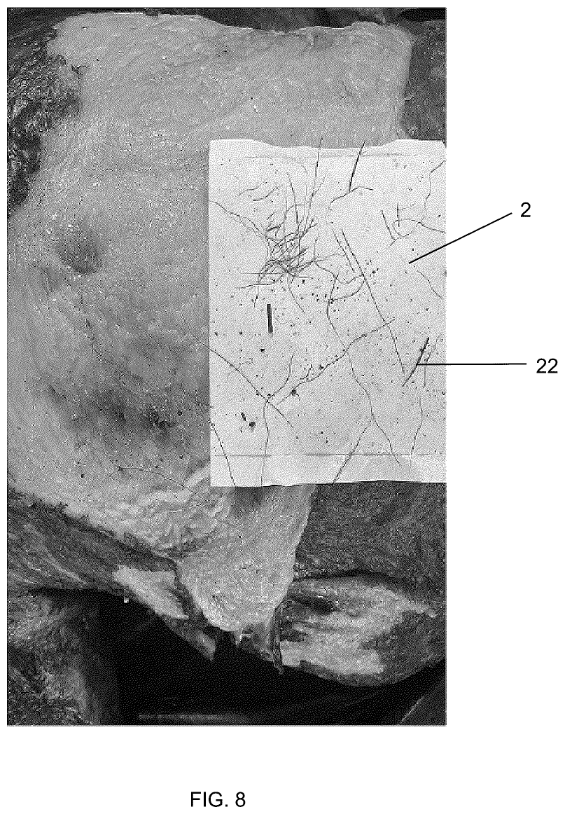

FIGS. 7 and 8 illustrate a further example of the use of an adhesive strip to remove hair from a section of an animal carcass. FIG. 7 illustrates the outer membrane and fat attached to the meat of the carcass. Debris 22 is stuck to the carcass 20. This debris includes dirt, hair, and plant matter. FIG. 8 illustrates the debris 22 from FIG. 7 adhered to the adhesive component 2 of the adhesive strip. The adhesive side of the adhesive strip has been pressed against the carcass, as in FIG. 3, causing the debris to stick to the adhesive. The adhesive strip is then pulled from the carcass. The tackiness of the adhesive is higher than the tackiness of the carcass, causing the debris to be removed with the strip when the strip is pulled from the carcass.

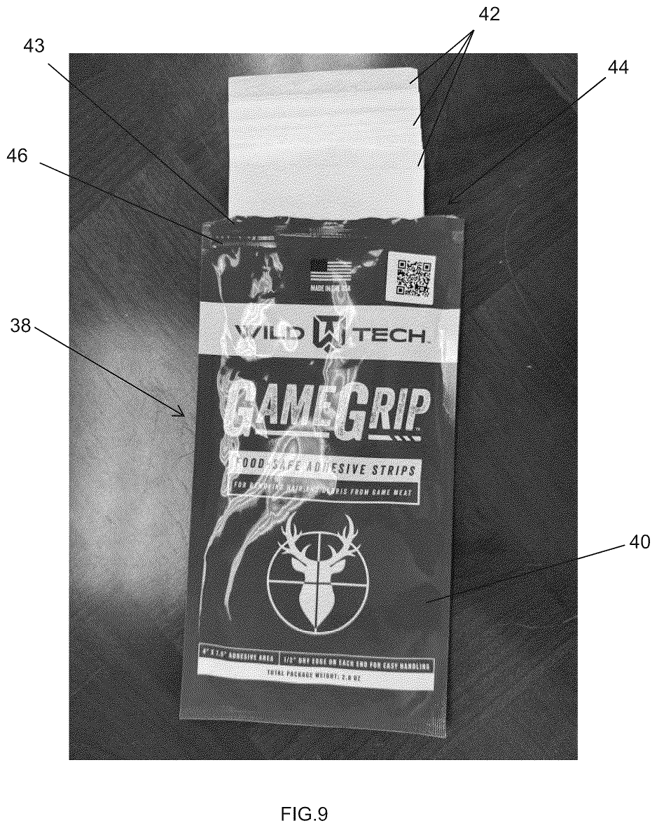

FIG. 9 illustrates a kit 38 of adhesive strips for use in removing debris from a carcass. A previously sealed pouch 40 is shown with a plurality of adhesive strips 42 as shown in FIGS. 1 and 2 is positioned partially in a pouch. The seal of the pouch has been broken to remove the adhesive strips. The pouch has an opening 44 to a chamber in which the adhesive strips are stored. The depicted pouch is resealable, with a resealable press seal 46 formed into the bag. The pouch is configured to house the plurality of adhesive strips. In a preferred embodiment the strips are 8.5 inches by 4 inches, as detailed above, and the pouch is 11.5 inches long by 5.5 inches wide. Preferably the pouch is sealed with a tear-able seal 43 that is configured to be ripped or torn off, and a second resealable mechanism positioned adjacent to it. This resealable mechanism is preferably a press fit or press seal, although alternate seal mechanisms, such as a zipper lock style seal may be used.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. An adhesive strip for removing debris from an animal carcass comprising:
a carrier sheet, said carrier strip comprising a adhesive side and a back face;
a food-safe adhesive adhered to the adhesive side of the carrier sheet;
a protective sheet positioned on top of the food-safe adhesive and on the adhesive side of the carrier sheet, wherein the protective sheet is configured for removal by a user such that the food-safe adhesive remains adhered to the adhesive side of the carrier sheet.

2. The adhesive strip of claim 1 wherein said adhesive side of the carrier sheet comprises a dry edge between the adhesive and a carrier sheet edge.

3. The adhesive strip of claim 2 wherein said carrier sheet comprises two dry edges positioned at opposite ends of said carrier strip.

4. The adhesive strip of claim 1 wherein said carrier strip comprises polyethylene terephthalate.

5. The adhesive strip of claim 1 wherein said adhesive has an effective range from a low temperature of −65 degrees Fahrenheit to a high temperature of 150 degrees Fahrenheit.

6. The adhesive strip of claim 1 wherein said adhesive is pressure sensitive.

7. The adhesive strip of claim 1 wherein said adhesive is an all-weather adhesive.

8. A method of using an adhesive strip to remove debris from a game carcass, said method comprising:
the step of providing an adhesive strip comprising
a carrier sheet, said carrier strip comprising an adhesive side and a back face;
a food-safe adhesive adhered to the adhesive side of the carrier sheet; and
a protective sheet positioned on top of the food-safe adhesive and on the adhesive side of the carrier sheet, wherein the protective sheet is configured for removal by a user such that the food-safe adhesive remains adhered to the adhesive side of the carrier sheet;
the step of removing the protective sheet from the adhesive side of the carrier sheet to expose the food-safe adhesive;
the step of pressing the adhesive side of the carrier sheet to an animal carcass to adhere debris on the animal carcass to the food safe adhesive;
the step of removing the adhesive strip from the animal carcass to remove the debris from the animal carcass along with the adhesive strip.

9. The adhesive strip of claim 8 wherein said adhesive side of the carrier sheet comprises a dry edge between the adhesive and a carrier sheet edge.

10. The adhesive strip of claim 9 wherein said carrier sheet comprises two dry edges positioned at opposite ends of said carrier strip.

11. The adhesive strip of claim 8 wherein said carrier strip comprises polyethylene terephthalate.

12. The adhesive strip of claim 8 wherein said adhesive has an effective range from a low temperature of −65 degrees Fahrenheit to a high temperature of 150 degrees Fahrenheit.

13. A kit for removing debris from a game carcass, said kit comprising:
a sealed pouch having a sealed opening and defining a chamber;
a plurality of adhesive strips positioned within said chamber of said bag, wherein each of said adhesive strips comprising:
a carrier sheet, said carrier strip comprising a adhesive side and a back face;
a food-safe adhesive adhered to the adhesive side of the carrier sheet;
a removable protective sheet positioned on top of the food-safe adhesive on the adhesive side of the carrier sheet, wherein the protective sheet is configured for removal by a user such that the food-safe adhesive remains adhered to the adhesive side of the carrier sheet.

14. The kit of claim 13 wherein said sealed pouch comprises a resealable bag.

15. The kit of claim 13 wherein said sealed pouch is configured for opening by ripping an end of said bag, wherein said pouch is reusable.

16. The kit of claim 13 wherein the adhesive side of each carrier sheet comprises a dry edge free of adhesive between the adhesive and each edge of the carrier sheet.

17. The kit of claim 15 wherein said dry edge is ½ inch in width.

18. The kit of claim 13 wherein said pouch is 5.5 inches wide by 11.5 inches long.
